(19) United States
(12) Patent Application Publication
(10) Pub. No.: US 2006/0194620 A1
(43) Pub. Date: Aug. 31, 2006

(54) Central alert for a cellular telephone

(76) Inventor: Donald Baskin, Memphis, TN (US)

Correspondence Address: LAW OFFICE OF DALE B. HALLING, LLC, 655 SOUTHPOINTE COURT, SUITE 100, COLORADO SPRINGS, CO, 80906, US

(21) Appl. No.: 11/364,904

(22) Filed: Feb. 27, 2006

Related U.S. Application Data
(60) Provisional application No. 60/657,130, filed on Feb. 28, 2005.

(51) Int. Cl. H04B 1/38

(52) U.S. Cl. 455/567

(57) ABSTRACT

A central alert for a cellular telephone has a cellular telephone with a call signal. A transmitter is coupled to the call signal and transmits the call signal. A central alert station has a receiver that receives the call signal.

### RELATED APPLICATIONS

The present invention claims priority on provisional patent application, Ser. No. 60/657,130, filed on Feb. 28, 2005, entitled “Transmitter Device with Communication Device with Speaker Device” and is hereby incorporated by reference.

### FIELD OF THE INVENTION

The present invention relates generally to the field of telephony and more particularly to a central alert for a cellular telephone.

### BACKGROUND OF THE INVENTION

The prevalence of cellular telephones and the continued reduction in the price of service for cellular telephones has resulted in a number of people using their cellular telephone as their main telephone. In fact, a number of people no longer have a landline telephone and rely solely on their cellular telephone. One of the problems that occurs, is that the owner of the cellular telephone does not want to carry their cellular telephone with them throughout their house (or office) constantly. As a result, when the phone rings (alerts the user to an incoming telephone call), the cellular telephone may not be close enough for the owner to hear it ring. As a result, the user misses a number of telephone calls.

Thus there exists a need for a device that can alert an owner that his cellular telephone has an incoming call, even when the user is not next to his cellular telephone.

### SUMMARY OF INVENTION

A central alert for a cellular telephone that overcomes these and other problems has a cellular telephone with a call signal. A transmitter is coupled to the call signal and transmits the call signal. A central alert station has a receiver that receives the call signal. The transmitter may be coupled to a headset input of the cellular telephone. The transmitter may transmit over an RF channel, a infrared channel or over an ultrasonic channel. The central alert station may be powered by a wall outlet.

In one embodiment, a central alert for a cellular telephone has an incoming call indicator. A receiver is coupled to the incoming call indicator and receives a call signal associated with a particular cellular telephone, wherein the receiver and the incoming call indicator are separate from the particular cellular telephone. The incoming call indicator may indicate a call with an audible sound or with a visual indicator. A transmitter may be electrically coupled to the particular cellular telephone and transmit the call signal to the receiver when the particular cellular telephone receives an incoming call indicator. The call signal may be from a cellular base station. The receiver may receive the call signal for a number of cellular telephones. The incoming call indicator may have a separate alert signal for each of the cellular telephones.

In one embodiment, a central alert for a cellular telephone has a number of incoming call indicators. A receiver is coupled to each of the incoming call indicators and receives a call signal associated with a particular cellular telephone, wherein the receivers and the incoming call indicators are physically remote from the particular cellular telephone. The receiver may receive the call signal for a number of cellular telephones. A transmitter may be electrically coupled to the particular cellular telephone and transmit the call signal to the receiver when the particular cellular telephone receives an-incoming call indicator. The call signal may be from a cellular base station.

### BRIEF DESCRIPTION OF THE DRAWINGS

FIG. 1 is a block diagram of a central alert for a cellular telephone in accordance with one embodiment of the invention; and

FIG. 2 is a block diagram of a central alert for a cellular telephone in accordance with one embodiment of the invention.

### DETAILED DESCRIPTION OF THE DRAWINGS

The present invention is a central alert system for a cellular telephone that provides a doorbell like function for a user's telephone. This system alerts the user in their house or business that their cellular telephone has an incoming call. The alerting stations can be placed throughout a residence so that the user will be aware of an incoming call no matter where they are in their house.

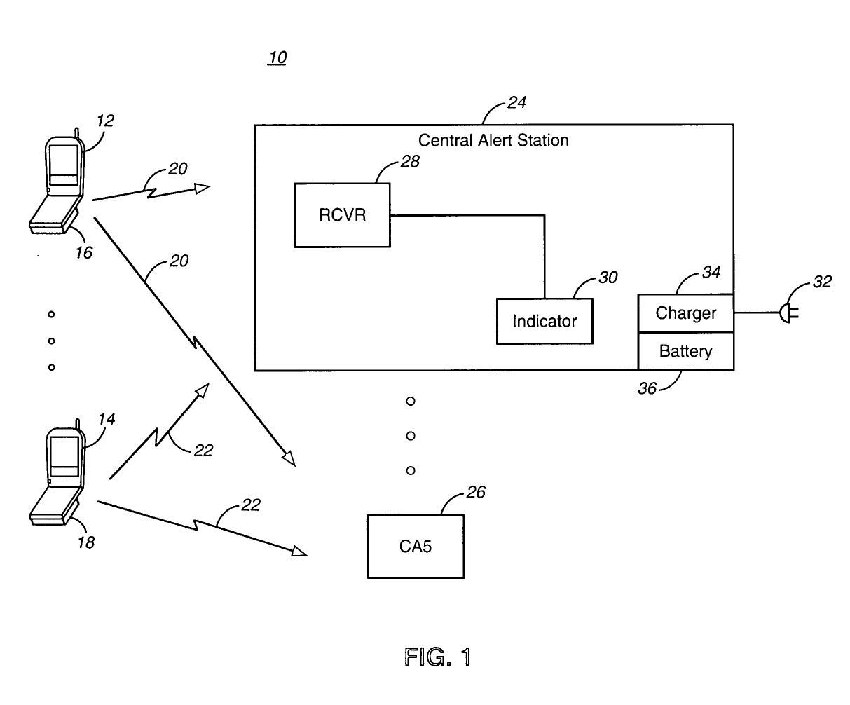

FIG. 1 is a block diagram of a central alert 10 for a cellular telephone 12, 14 in accordance with one embodiment of the invention. The system 10 has a transmitter 16, 18 that attaches to the cellular telephone 12, 14. The transmitter detects a ring signal (incoming call indicator) and transmits a call signal 20, 22 to one or more central alert stations 24, 26. Each central alert station 24 has a receiver 28 that receives the call signal 20, 22 and causes an indicator 30 to produces an indication that there is an incoming call for a particular cellular telephone 16 or 18. In one embodiment the transmitter 16, 18 is coupled through a headset input of the cellular telephone 12, 14. In one embodiment, the ring tone is transmitted from the transmitter 16 to the central alert station 24. The central alert station plays the ring tone on a speaker. Since most people have different ring tones for there cellular telephones, the people in a household can tell if the call is for them. The central alert 24 speaker includes a volume adjustment in one embodiment.

The call signal 20, 22 may be over an RF (Radio Frequency) channel, Infrared channel, ultrasonic channel or any other wireless channel. In one embodiment, the call signal 20, 22 uses an unlicensed part of the electromagnetic spectrum. In one embodiment the central alert station 24 is powered by a wall outlet 32. The wall outlet 32 may be connected to a charger 34 that charges some batteries 36. This system ensures that the central alert system 24 will work even if the power is out, but does not rely on expensive batteries.

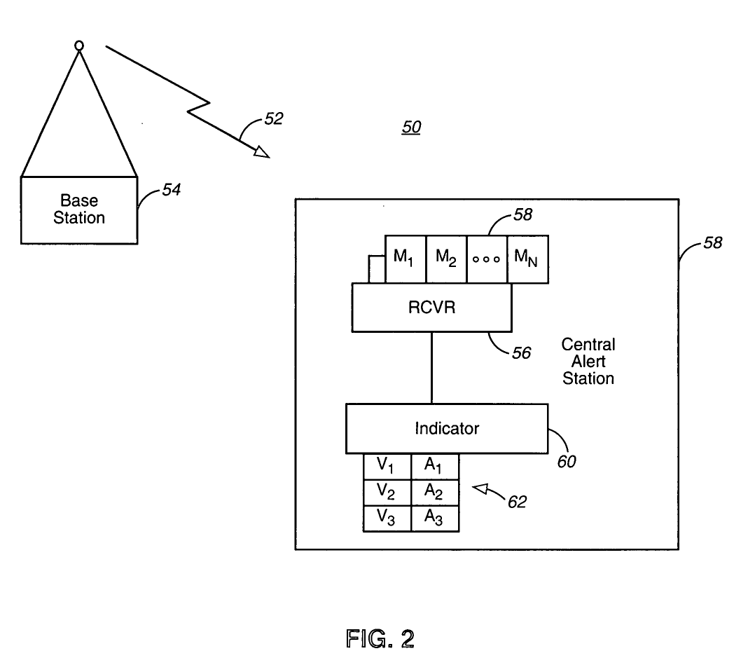

FIG. 2 is a block diagram of a central alert 50 for a cellular telephone in accordance with one embodiment of the invention. In this embodiment, the central alert system 50 receives the incoming call signal 52 from a cellular base station 54. This eliminates the need for the transmitter 16, 18 shown in the embodiment of FIG. 1. A receiver 56 at the central alert station 58 receives the incoming call signal 52. The receiver 56 has a memory 58 that allows it to receive the call signal 52 for a number of cellular telephone numbers. When the receiver detects a call signal 52 it causes the indicator 60 to activate the appropriate indicator 62. Note that there may be multiple visual (V1, V2, V3) and audio (A1, A2, A3) indicators. Each of the indicators may be associated with a separate cellular telephone number or one visual and one audio indicator may be associated with a single telephone number.

Thus there has been described a central alert system for a cellular telephone that provides a doorbell like function for a user's telephone. This system alerts the user in their house or business that their cellular telephone has an incoming call. The alerting stations may be placed throughout a residence so that the user will be aware of an incoming call no matter where they are in their house.

As used herein the phrase “cellular telephone” includes any mobile communication device, such as a satellite telephone, portable IP (Internet Protocol) devices, but does not include in-house wireless telephone systems that use landlines, since these are fixed to within a small distance from a home base station.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A central alert for a cellular telephone, comprising:
a cellular telephone having a call signal;
a transmitter coupled to the call signal, transmitting the call signal; and
a central alert station having a receiver receiving the call signal.

2. The central alert of claim 1, wherein the transmitter is coupled to a headset input of the cellular telephone.

3. The central alert of claim 1, wherein the transmitter transmits over an RF channel.

4. The central alert of claim 1, wherein the transmitter transits over a infrared channel.

5. The central alert of claim 1, wherein the transmitter transits over a ultrasonic channel.

6. The central alert of claim 1, wherein the central alert station is powered by a wall outlet.

7. A central alert for a cellular telephone, comprising:
an incoming call indicator; and
a receiver coupled to the incoming call indicator and receiving a call signal associated with a particular cellular telephone, wherein the receiver and the incoming call indicator are separate from the particular cellular telephone.

8. The central alert of claim 7, wherein the incoming call indicator indicates a call with an audible sound.

9. The central alert of claim 7, wherein the incoming call indicator indicates a call with a visual indicator.

10. The central alert of claim 7, further including a transmitter electrically coupled to the particular cellular telephone and transmitting the call signal to the receiver when the particular cellular telephone receives an incoming call indicator.

11. The central alert of claim 7, wherein the call signal is from a cellular base station.

12. The central alert of claim 11, wherein the receiver receives the call signal for a plurality of cellular telephones.

13. The central alert of claim 12, wherein the incoming call indicator has a separate alert signal for each of the plurality of cellular telephones.

14. A central alert for a cellular telephone, comprising:
a plurality of incoming call indicators; and
a receiver coupled to each of the plurality of incoming call indicators and receiving a call signal associated with a particular cellular telephone, wherein the receivers and the plurality of incoming call indicators are physically remote from the particular cellular telephone.

15. The central alert of claim 14, wherein the receiver receives the call signal for a plurality of cellular telephones.

16. The central alert of claim 15, further including a transmitter electrically coupled to the particular cellular telephone and transmitting the call signal to the receiver when the particular cellular telephone receives an incoming call indicator.

17. The central alert of claim 15, wherein the call signal is from a cellular base station.
